(19) United States
(12) Patent Application Publication
(10) Pub. No.: US 2016/0306603 A1
(43) Pub. Date: Oct. 20, 2016

(54) INTERACTIVE DISPLAY SYSTEM FOR SWIMMING POOLS

(71) Applicant: Appycentre Pty Ltd, Prahran (AU)

(72) Inventor: Sankar Nadeson, Prahran (AU)

(21) Appl. No.: 15/099,967

(22) Filed: Apr. 15, 2016

(30) Foreign Application Priority Data
Apr. 15, 2015 (AU) 2015901353

(51) Int. Cl. G06F 3/14; G06F 3/0484; G09B 5/02; G08B 21/04; G06F 1/16; A63B 69/12; G06F 3/01; G06F 3/0481

(52) U.S. Cl. CPC G06F 3/1446; G06F 3/011; G06F 3/04847; G06F 3/0481; G08B 21/0415; G06F 1/1656; A63B 69/12; G09B 5/02

(57) ABSTRACT

In one embodiment, an interactive display system for a swimming pool comprises: one or more waterproof light emitting diode (LED) displays submersible in a swimming pool; and a controller to control display parameters of the one or more waterproof LED displays in response to user input or interaction.

### FIELD

The present invention relates to an interactive display system for swimming pools.

### BACKGROUND

Swimming pools are conventionally decorated or enhanced with tiling, inlays or lighting systems.

Existing approaches to decorating or enhancing the appearance, mood and experience of swimming pools have various problems. Tiling and inlays have a static appearance that is not modifiable without physically replacing them. Pool lighting systems generally produce light that is only modifiable by changing colour and/or luminosity.

In this context, there is a need for solutions that address the above problems.

### SUMMARY

According to the present invention, there is provided a system, comprising;

one or more waterproof light emitting diode (LED) displays submersible in a swimming pool; and

a controller to control display parameters of the one or more waterproof LED displays in response to user input or interaction.

The system may further comprise a user interface to the controller to enable the display parameters of the one or more waterproof LED displays to be varied by the controller in response to user input. The user interface may comprise a user interface of a web application, a mobile application, or a combination thereof.

The system may further comprise one or more sensors to detect or capture motion of a body either wholly or partially underwater in the swimming pool to enable the display parameters of the one or more waterproof LED displays to be varied by the controller in response to user interaction. The one or more sensors may comprise cameras, motion detectors, and combinations thereof.

The system may further comprise interactive software executed by the controller, wherein the interactive software comprises graphics display software, motion detection software, motion capture software, and combinations thereof.

The controller may comprise a programmable processor, a single board computer, a computing device, and combinations thereof.

The controller may initiate an alarm event in response to detecting absence of motion of the body either wholly or partially underwater in the swimming pool for a predetermined time period. The alarm may be communicated by a siren, an instant message, an email, the one or more LED displays, and combinations thereof.

The one or more waterproof LED displays may comprise LED arrays, LED strips, LED tiles, and combinations thereof. For example, LED strips may be arranged on one or more sides of the swimming pool, and LED tiles may be arranged in a modular array on a floor of the swimming pool. Further, the waterproof LED displays, such as modular LED tiles, may be applied to the internal walls and floor of the swimming pool, and to external feature walls surrounding the swimming pool.

Each waterproof LED display may comprise one or more LEDs sealingly enclosed in a waterproof housing.

Each waterproof LED display may be removably submersible in the swimming pool. For example, each waterproof LED display may be removably fastened to a tray mounted on the floor of the swimming pool.

The swimming pool may comprise a pool, a spa, a pond, a lagoon, and combinations thereof.

The present invention also provides a swimming pool comprising the system described above.

The present invention also provides a method of operating a swimming pool using the system described above.

The present invention further provides a method of providing interactive gaming or immersive education in a swimming pool using the system described above.

The present invention also provides a method of monitoring safety of a swimming pool using the system described above.

The present invention further provides a method of providing swim coaching using the system described above.

### BRIEF DESCRIPTION OF DRAWINGS

Embodiments of the invention will now be described by way of example only with reference to the accompanying drawings, in which:

FIGS. 1 is a block diagram of an interactive display system for swimming pools according to an embodiment of the present invention;

FIGS. 2 and 3 are schematic top and side views of the system; and

FIGS. 4 and 5 are top and rear perspective views of an waterproof LED display used in the system.

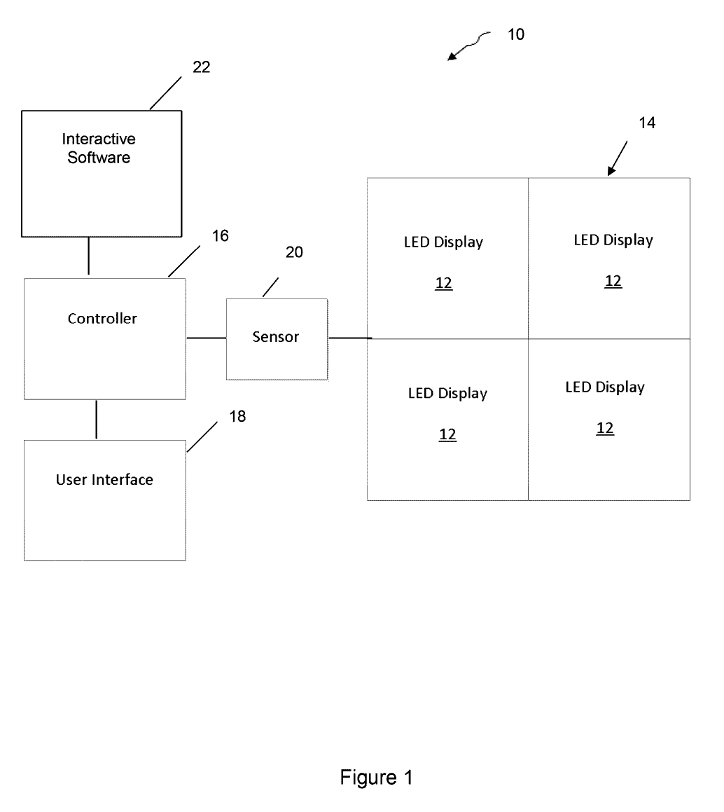

### DETAILED DESCRIPTION

Referring to the drawings, an interactive display system 10 for swimming pools according to an embodiment of the present invention may generally comprise a plurality of waterproof LED displays 12 submersible in a swimming pool 14, and a controller 16 to selectively and individually control display parameters of the waterproof LED displays 12 in response to user input or interaction. The display parameters may comprise information relating to digital media content, such as text, movies, photos, images, graphics and patterns, displayed by the waterproof LED displays 12. The swimming pool 14 may comprise a pool, a spa, a pond, a lagoon, and combinations thereof. The system 10 may further comprise a user interface 18 to the controller 16 to enable the display parameters of the waterproof LED displays 12 to be varied by the controller 16 in response to user input. The user interface 18 may comprise a user interface of a web application, a mobile application, or a combination thereof.

The system 10 may further comprise one or more sensors 20 to detect or capture motion of a body either wholly or partially underwater in one or more zones of the swimming pool 14 to enable the display parameters of the waterproof LED displays 12 to be varied by the controller 16 in response to user interaction. The one or more sensors 20 may comprise cameras, motion detectors, and combinations thereof. The one or more sensors 20 may be wall- or floor-mounted in the swimming pool 14 and may have fields of view oriented to the one or more zones of the swimming pool 14. Further or alternatively, the one or more sensors 20 may be wholly or partially mounted or arranged externally of the swimming pool 14. Each sensor 20 may be enclosed in a waterproof housing.

The system 10 may further comprise interactive software 22 executed by the controller 16. The interactive software 22 may comprise graphics display software, motion detection software, motion capture software, and combinations thereof. For example, graphics display software may enable a user to select and manipulate graphics, images, patterns or videos to be displayed by the waterproof LED displays 12. The graphics, images or patterns may be moving and/or static. The waterproof LED displays 12 may be interactively configured by users to change the use, mood, appearance or experience of the swimming pool 14. For example, child-friendly or stimulating images or patterns may be interactively displayed by the interactive display system 10 when the swimming pool is being used by children for play and recreation. Alternatively, the graphics, images and patterns displayed by the waterproof LED displays 12 of the system 10 may be interactively changed by users to lane markers and lap timing information when the swimming pool 14 is used by adults for swimming laps for training or competition.

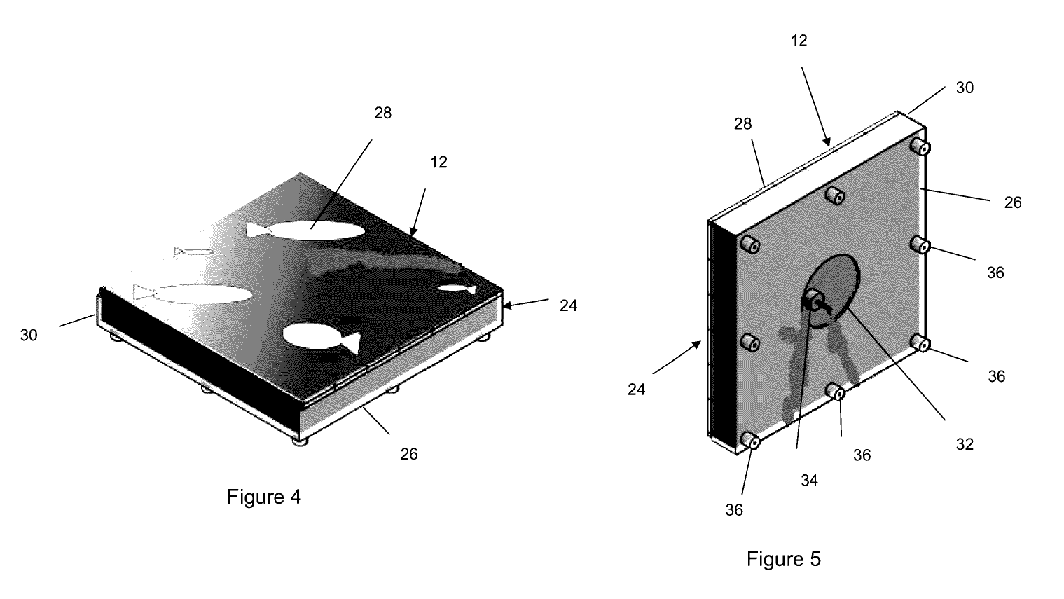

The motion detection software of the system 10 may enable presence or absence of motion, and/or location, of a body of a swimmer either wholly or partially underwater in the swimming pool to be detected and determined for safety monitoring of the swimming pool, or for interactive gaming or immersive education with the swimming pool. The motion detection software may also enable size, height, width, location, zone, direction, and speed of the body to be determined. For example, the system 10 may be used to gamify a swimming pool 14 by dynamically displaying virtual fish on the waterproof LED displays 12, as illustrated in FIG. 4. The virtual fish may move around on the floor of the swimming pool 14 in response to the changing position of the children to enable them to interact and play with the virtual fish during swimming in the swimming pool 14. Further, the system 10 may be used as an educational tool, for example, for children in remote indigenous communities, to provide immersive, interactive story telling within the swimming pool 14.

Further, the motion capture software of the system 10 may enable motion of a body, such as arm and leg motion during swimming, to be captured and biomechanically analysed for timing, speed and stroke for swimming coaching.

The controller 16 may comprise one or more of a programmable processor, a single board computer, a computing device, and combinations thereof. For example, the controller 16 may comprise one or more Rasberry Pi or Beagleboard single board computers connected to one or more of the waterproof LED displays 12 and one or more of the sensors 20.

The controller 16 may be programmed to initiate an alarm event in response to the motion detection software detecting absence of motion of the body either wholly or partially underwater in the swimming pool 14 for a predetermined time period that represents a drowning or unconscious user in the swimming pool 14. The controller 16 may comprise a network or communications interface (not shown) to communicate the alarm event by a siren, an instant message, an email, the one or more LED displays, and combinations thereof. For example, a siren may be sounded, an instant message or email may be sent to a mobile application on a smartphone or smart watch, and the position of the drowning or unconscious user in the swimming pool 14 may be visually indicated by a hazard symbol displayed one or more of the waterproof LED displays 12.

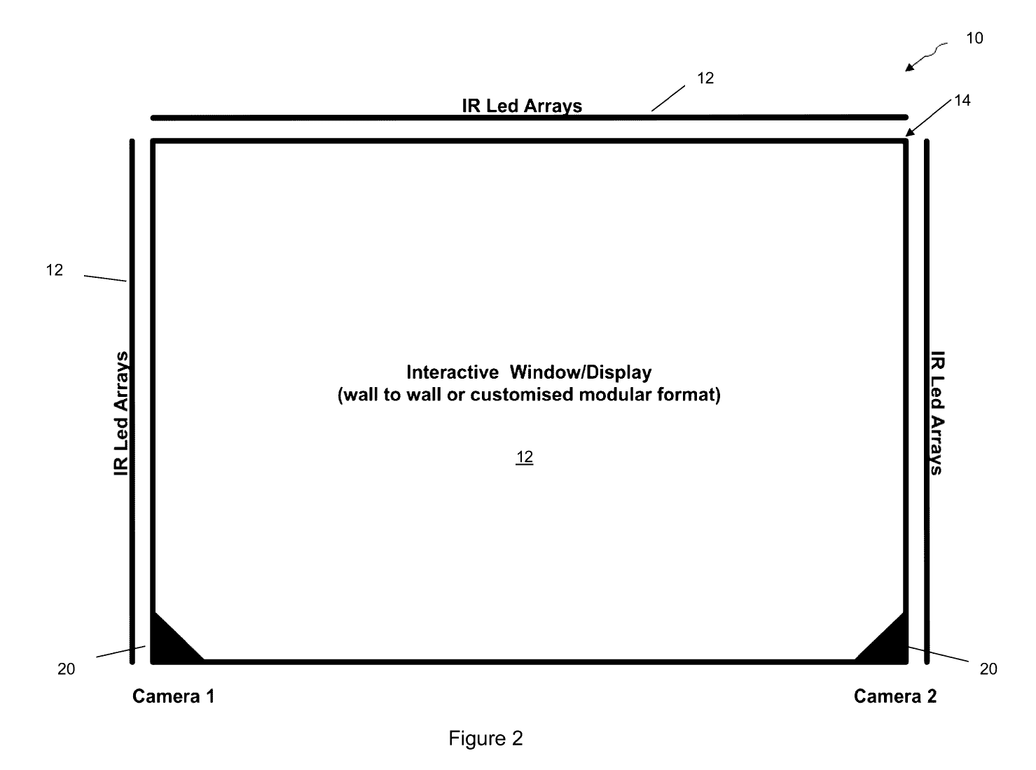

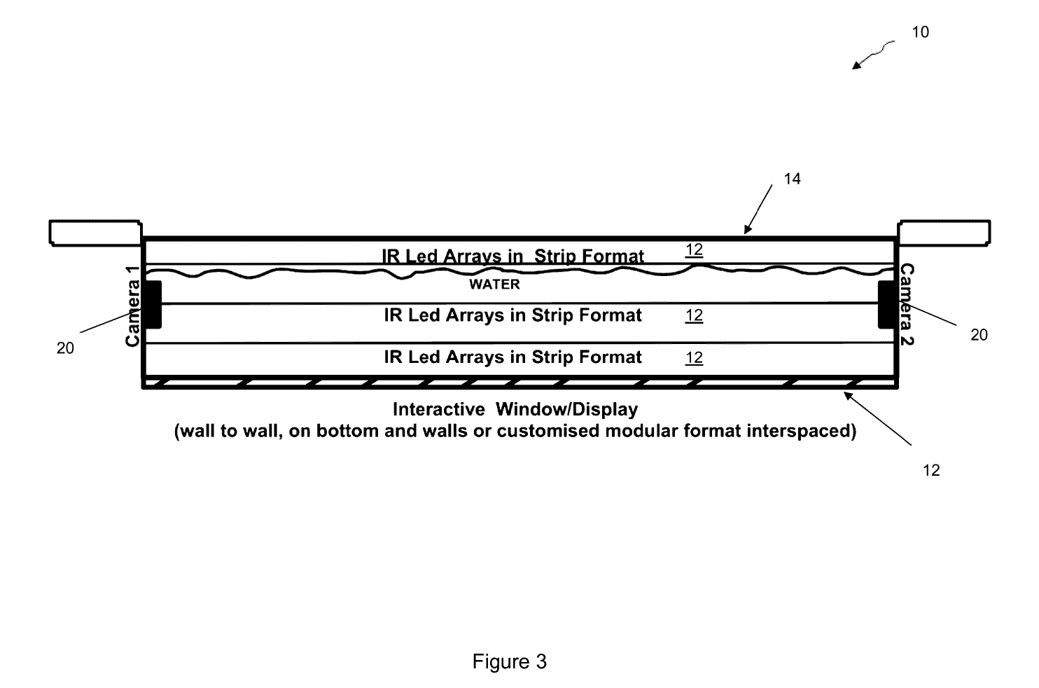

The waterproof LED displays 12 may comprise LED arrays, LED strips, LED tiles, and combinations thereof. The waterproof LED displays 12 may be wall- or floor-mounted in the swimming pool 14. The LED displays 12 may further comprise infrared filters, and individually addressable and colour-changeable LEDs to enable sections of the LEDs to be selectively activated. For example, as illustrated in FIGS. 2 and 3, LED strips 12 may be arranged on one or more sides of the swimming pool 14, and LED tiles 12 may be arranged in a modular array on a floor of the swimming pool 14. Further, the waterproof LED displays 12, such as modular LED tiles, may be applied to the internal walls and floor of the swimming pool 14, and to external feature walls surrounding the swimming pool 14.

As illustrated in FIGS. 4 and 5, each waterproof LED display 12 may comprise one or more LED display panels 12 sealingly enclosed in a waterproof housing 24. Each waterproof housing 24 may comprise a rectangular box having a planar base 26, top 28 and sides 30. At least the top 28 of each waterproof housing 24 may be transparent. Each waterproof housing 24 may be formed, for example, from Perspex or other transparent and/or translucent materials. The base 26 may comprise a compartment 32 for internal electrical and data cabling to the LED display 12. The base 26 may further comprise a submersible connector 34 for external electrical and data cabling from the LED display 10 to the controller 16 and a power supply (not shown).

Each waterproof LED display 12 may be removably submersible in the swimming pool 14. For example, each waterproof LED display 12 may be removably fastened, for example, by screws 36, to a tray insert (not shown) mounted on the floor of the swimming pool 14.

Embodiments of the present invention provide an interactive display system for swimming pools that is useful for enhancing pool user experience, pool safety monitoring, pool interactive gaming, pool immersive education, and swimming coaching.

For the purpose of this specification, the word “comprising” means “including but not limited to,” and the word “comprises” has a corresponding meaning.

The above embodiments have been described by way of example only and modifications are possible within the scope of the claims that follow.

1. A system, comprising:
one or more waterproof light emitting diode (LED) displays submersible in a swimming pool; and
a controller to control display parameters of the one or more waterproof LED displays in response to user input or interaction.

2. The system of claim 1, further comprising a user interface to the controller to enable the display parameters of the one or more waterproof LED displays to be varied by the controller in response to user input.

3. The system of claim 2, wherein the user interface is a user interface of a web application, a mobile application, or a combination thereof.

4. The system of claim 2, further comprising one or more sensors to detect or capture motion of a body either wholly or partially underwater in the swimming pool to enable the display parameters of the one or more waterproof LED displays to be varied by the controller in response to user interaction.

5. The system of claim 4, wherein the one or more sensors comprise cameras, motion detectors, and combinations thereof.

6. The system of claim 4, further comprising interactive software executed by the controller, wherein the interactive software comprises graphics display software, motion detection software, motion capture software, and combinations thereof.

7. The system of claim 1, wherein the controller comprises a programmable processor, a single board computer, a computing device, and combinations thereof.

8. The system of claim 4, wherein the controller initiates an alarm event in response to detecting absence of motion of the body either wholly or partially underwater in the swimming pool for a predetermined time period.

9. The system of claim 8, wherein the alarm event is communicated by a siren, an instant message, an email, the one or more LED displays, and combinations thereof.

10. The system of claim 1, wherein the one or more waterproof LED displays comprise LED arrays, LED strips, LED tiles, and combinations thereof.

11. The system of claim 10, wherein LED strips are arranged on one or more sides of the swimming pool, and/or LED tiles are arranged in a modular array on a floor of the swimming pool.

12. The system of claim 1, wherein each waterproof LED display comprises one or more LEDs sealingly enclosed in a waterproof housing.

13. The system of claim 1, wherein each waterproof LED display is removably submersible in the swimming pool.

14. The system of claim 13, wherein each waterproof LED display is removably fastened to a tray mounted on the floor of the swimming pool.

15. The system of claim 1, wherein the swimming pool comprises a pool, a spa, a pond, a lagoon, and combinations thereof.

16. A swimming pool comprising the system of claim 1.

17. A method of operating a swimming pool using the system of claim 1.

18. A method of providing interactive gaming or immersive education in a swimming pool using the system of claim 1.

19. A method of monitoring safety of a swimming pool using the system of claim 1.

20. A method of providing swim coaching using the system of claim 1.
